(19) United States
(12) Patent Application Publication
(10) Pub. No.: US 2013/0035971 A1
(43) Pub. Date: Feb. 7, 2013

(54) Computing Systems And Methods For Statistically Characterizing An Organization

(71) Applicant: Michael Bruce, New York, NY (US)

(72) Inventor: Michael Bruce, New York, NY (US)

(21) Appl. No.: 13/196,736

(22) Filed: Aug. 2, 2011

(51) Int. Cl. G06Q 10/00

(52) U.S. Cl. 705/7.11

(57) ABSTRACT

The present invention is directed to computing systems and methods for gathering, analyzing, and presenting information to statistically characterize an organization. In one aspect of the invention, a computing system includes computer readable medium(s) having characteristics regarding organizations, data showing how the characteristics relate to a first organization and showing how the characteristics relate to other organizations, and software for analyzing the data to determine distinctive characteristics of the first organization. The computing system includes processor(s) executing the software, which when executed causes the system to identify a first characteristic that, statistically more than any of the other characteristics, relates to the first organization more than it relates to other organizations. Various other aspects and embodiments of the invention are disclosed.

### FIELD OF THE INVENTION

The disclosed invention generally relates to the field of information processing. More specifically, the disclosed invention relates to computing systems and methods for gathering, analyzing, and presenting information to statistically characterize an organization (or workgroups within an organization).

### BACKGROUND OF THE INVENTION

Most organizations look for similar qualities in their employees, and these days, savvy organizations are developing employer brands that communicate values and principles that they think are sought by job seekers. These organizations sincerely want to address what they think people want from an employer. There are, however, several drawbacks to this approach. For example, by emphasizing perceptions of what applicants seek, such an approach may fail to distinguish an organization from its competitors, presenting potential candidates with the same “desirable” characteristic every other “employer of choice” is offering. Additionally, such approaches are generally based on imprecise qualitative perceptions.

Existing systems fail to account for the unarticulated side of an individual that he or she would like to be able to express at work. These are not qualities inherent in the job title or description, but rather unique individual characteristics that employees tap into that support success in a particular job environment.

Say for instance that a job environment's most distinctive qualities are that it provides less training, is more stressful, and pays somewhat less than competitors. Existing systems would deemphasize these qualities and characterize them as undesirable to candidates. What the existing systems fail to recognize, however, is that there are “right-fit” candidates for these characteristics, such as, for example, individuals who really enjoy calling their own shots and find their greatest reward in overcoming obstacles. In this example, the “hidden motivators” are employee autonomy and achievement. Such individuals in this example may think of themselves as “go to” people or “fixers”—this would be their unarticulated side, the secret side of them that existing systems would not recognize and validate. This unarticulated side in each individual is what some psychologists refer to as the “idealized self.” The “idealized self” represents those highly valued qualities that the individual would not articulate to a potential employer for fear of appearing too egotistical. Employees who find that their unarticulated side is being recognized and appreciated are more highly motivated towards a job and will find greater satisfaction within the work environment.

Existing systems simply fail to identify the distinctive qualities for a job environment compared to competitors. Rather, existing systems tend to identify the things that every applicant desires in every job, giving the potential employer little to no distinction relative to its competitors. Additionally, existing systems are based on imprecise qualitative perceptions. Accordingly, there is need in the art for a computational approach that aims to statistically characterize distinctive qualities in the jobs in an organization.

### SUMMARY OF THE INVENTION

The disclosed invention is directed to computing systems and methods for gathering, analyzing, and presenting information to statistically characterize an organization. Various embodiments and methods disclosed herein can operate on one or more computers.

In one aspect of the disclosed invention, a computing system is disclosed for statistically characterizing an organization and its different workgroups. The computing system includes one or more computer readable medium having characteristics regarding organizations, data regarding the characteristics in relation to a first organization and regarding the characteristics in relation to other organizations, and software for analyzing the data to determine distinctive characteristics of the first organization. The computing system also includes processor(s) executing the software, wherein the software when executed causes the computing system to identify, based on data, a first characteristic among the characteristics that, statistically more than any of the other characteristics, relates to the first organization more than it relates to other organizations. In one embodiment, the software when executed also causes the computing system to identify, based on the data, a second characteristic among the characteristics that, statistically more than any of the other characteristics, relates to other organizations more than it relates to the first organization.

In one embodiment, the data includes survey responses indicating how the characteristics relate to the first organization and how the characteristics relate to the other organizations. In one embodiment, the computing system includes software for gathering the survey responses. In one embodiment, the survey response includes at least four levels indicating how the characteristics relate to the first organization and how the characteristics relate to the other organizations.

In one embodiment, the software when executed causes the computing system to, for each characteristic, compute a first average value indicating the average of the survey responses indicating how the characteristic relates to the first organization, compute a second average value indicating the average of the survey responses indicating how the characteristic relates to the other organizations, and compute a difference between the first average value and the second average value. In one embodiment, computing the first average value and the second average value involve an assignment table that associates values with survey responses. In one embodiment, the assignment table associates values with survey responses based on a starving man premise. In one embodiment, identifying the first characteristic involves identifying the one characteristic having the most positive-valued difference among the characteristics. In one embodiment, identifying the second characteristic involves identifying the one characteristic having the most negative-valued difference among the characteristics.

In one embodiment, the software when executed causes the computing system to compute similarity between one or more of the survey responses and the first characteristic. In one embodiment, the software when executed causes the computing system to compute similarity between one or more of the survey responses and the second characteristic.

Aspects and embodiments of the disclosed invention will become apparent from the following brief description of the drawings in conjunction with the detailed description of the invention.

### BRIEF DESCRIPTION OF THE DRAWINGS

In the drawings:

FIG. 1 is a block diagram of an exemplary network configuration for operating the disclosed invention;

FIG. 2 is a block diagram of an exemplary host computer in accordance with aspects of the disclosed invention;

FIG. 3 is a diagram of an exemplary survey in accordance with aspects of the disclosed invention;

FIG. 4 is a diagram of an exemplary interface for a respondent to enter insightful responses;

FIG. 5 is a diagram of an exemplary display showing respondent answers showing how a particular characteristic relates to the current job and to the previous job;

FIG. 6 is a diagram of another exemplary display showing respondent answers showing how a particular characteristic relates to the current job and to the previous job;

FIG. 7 is a diagram of an exemplary display showing an analysis of respondent answers showing which characteristics relate to the subject organization more than other organizations and showing which characteristics relate to other organizations more than the current organization;

FIG. 8 is a diagram of an exemplary display showing similarities between respondent answers and average answers for particular questions;

FIG. 9 is a table showing exemplary respondent data for three questions having most positive-valued differences;

FIG. 10 is a table showing exemplary similarity computations based on the respondent data of FIG. 9;

FIG. 11 is a table showing exemplary respondent data for three questions having most negative-valued differences;

FIG. 12 is a table showing exemplary similarity computations based on the respondent data of FIG. 11;

FIG. 13 is a diagram of an exemplary display showing a particular respondent's information and answers to questions.

### DETAILED DESCRIPTION OF THE INVENTION

The disclosed invention is directed to computing systems and methods for gathering, analyzing, and presenting information to statistically characterize an organization. More specifically, the disclosed invention is directed to identifying the “hidden motivators” in a workplace that can assist an organization in becoming the employer of choice for “right-fit” candidates. In this manner, the disclosed invention can determine what differentiates an employer and any of its workgroups compared to others and thereby enable an organization to effectively communicate what makes its job environments distinctive relative to its competitors. Embodiments of the disclosed invention can quantify insight relative to competition, at the job environment level, for any selected position within an organization. The embodiments and methods disclosed herein can operate on a computer and/or any other computing device.

A recent report on leading a multigenerational workforce indicates: (1) competition for talent is escalating; (2) more generations are working side-by-side; (3) productivity and business results are linked to work environment. Whether it is due to the needs of a diverse workforce or current competitive trends, now more than ever, people feel empowered to express their desire to be more self-actualized in their work.

At the same time, more workers are looking for self-actualization in their jobs; they are looking to know that their talents are truly appreciated. Thus, organizations need better tools to help them attract top candidates who have a greater chance of being fulfilled in their jobs. Versus bygone times when employers were simply required to provide a paycheck and benefits for hours worked, companies are looking for engaged employees—those who are willing and able to contribute to organizational success. The disclosed invention enables organizations to uncover their hidden motivators, i.e., those characteristics that make their job environments distinctive relative to competitors, and thus to explore whether these distinctions match with an appeal to an applicant's desire “to do something that they love.”

Distinctions relative to competitors, as well as distinctions among job environments within one organization, always exist. For example, some job environments have a “sink or swim” mentality while others offer extensive training; one organization encourages risk-taking, while another focuses on caution. By understanding and embracing its unique characteristics, an organization creates the opportunity to build a workforce that values what it has to offer. This approach generates better opportunities for a solid fit from the beginning of the employment relationship, leading to the organization attracting more highly motivated “right-fit” candidates. Taking this approach provides employees with a more accurate picture of the organization's job environment, leading to greater job satisfaction, which ultimately equates to reduced recruitment and turnover costs and increased job performance and employee tenure. The disclosed invention is directed to computing systems and methods that provide statistical information on an organization's differentiating characteristics. This information enables an organization to find “right-fit” candidates.

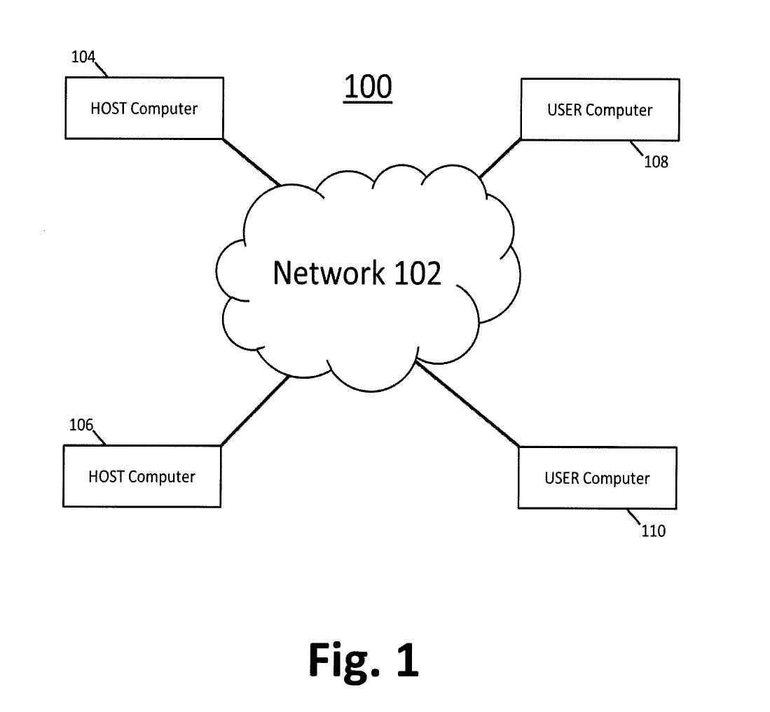

Turning now to the figures, FIG. 1 shows an illustrative network configuration 100 for operating the disclosed invention. The illustrated network configuration 100 includes a network 102, one or more host computers 104, 106, and one or more user computers 108, 110, in which the user computers and host computers can communicate through the network 102. As referred to herein, a “computer” can include one or more desktops, laptops, netbooks, handheld devices, servers, network communication devices (for example, routers, hubs, switches), and/or other computing devices, all of which can be located proximate to each other or remote from each other. The network 102 can include part or all of one or more types of communication networks such as, for example, a cable system, cellular telephone system, a telephone network system, a wired and/or wireless local area network, wide area network, or metropolitan area network, and/or any other type of communication network. The network 102 can include one or more types of communication mediums, including, for example, wireless over the air, coaxial cable, copper twisted wire, and/or fiber optic cable. The network 102 and the computers 104-110 in communication with it can employ communication protocols that will be known to those skilled in the art, including, for example, any packet-based communications protocols. The illustrated configuration 100 is exemplary and does not limit the scope of the disclosed invention. For example, although two host computers 104, 106 are illustrated, the disclosed invention can operate with another number of host computers.

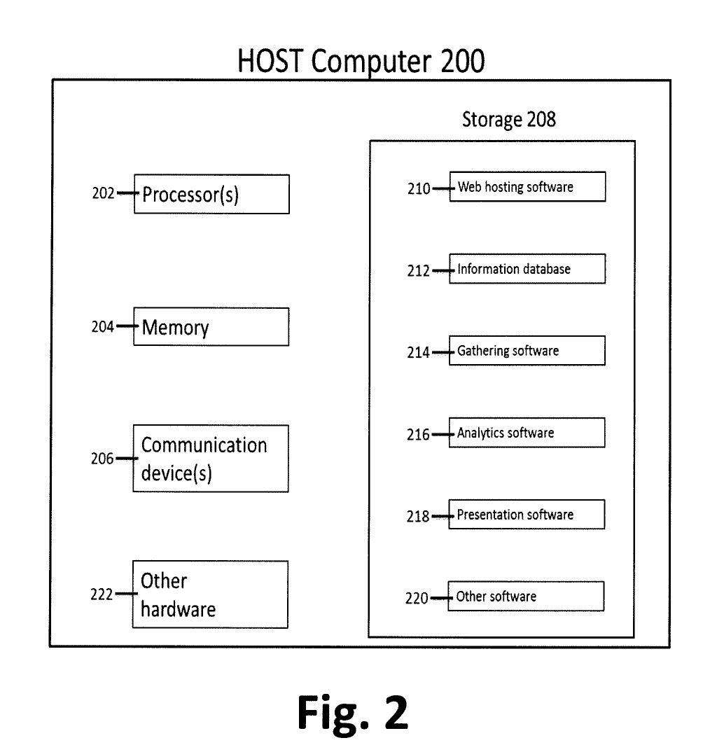

Referring now to FIG. 2, there is shown a block diagram of one embodiment of a host computer 200 in accordance with aspects of the disclosed invention. In the illustrated embodiment, the host computer 200 can include one or more processor(s) 202, memory 204, communication device(s) 206, and one or more storage 208, among other hardware 222 and other things that will be known to those skilled in the art. In the illustrated embodiment, the storage 208 can contain software and information, such as web hosting software 210, an information database 212, gathering software 214, analytics software 216, presentation software 218, and other software 220. The web hosting software 210 will be known to those skilled in the art. The other components 212-218 will be described in more detail later herein.

In summary, the information database 212 can include electronic information about an organization, including surveys, survey responses, and results of statistical computations. The gathering software 214 can include software that presents questions to users and receives responses from users regarding an organization. In one embodiment, the questions and responses can be stored in the information database 212. The analytics software 216 can include computations and formulas that process the questions and responses to provide a statistical characterization of the organization. The presentation software 218 can include software for presenting the computation results and statistical characterization, and can include the ability for users to customize the presentation or to view different perspectives of the computation results, which will be described in more detail later herein. The storage 208 can also include other software 220 that may work in conjunction with the software and database 210-218, such as operating system software, programming software (such as C++ or Java), and others that will be recognized by those skilled in the art.

Those skilled in the art will understand that software and information in the storage 208 can be communicated to and from the processor(s) 202 and the memory 204, and that when the processor 202 executes software instructions, the host computer 200 will be caused to perform the steps, features, and functions of the executed software. The storage 208 can be any computer readable medium. As used herein, a “computer readable medium” can include one or more of: random access memory, read only memory, hard disks, floppy disks, compact disks, DVDs, flash drives, solid state disks, tape drives, and/or any other type of device or medium capable of storing information temporarily and/or permanently. In various embodiments, operations of a host computer 200 can utilize one or more of the disclosed components 202-222. The illustrated host computer 200 and its components are exemplary and do not limit the scope of the disclosed invention. Other embodiments are contemplated to fall within the scope of the disclosed invention. For example, a host computer can be deployed as multiple computers in a region or multiple networked computers distributed across different regions that communicate with each other over a communication network. In various embodiments, the software and information 210-220 can exist on and/or across multiple computers. It is contemplated that the various embodiments disclosed herein are not exclusive and can be used in one or more combinations to provide the disclosed invention.

What has been described above are system configurations and system components for operating aspects and embodiments of the disclosed invention. The following description will now describe in more detail aspects and embodiments of the information database 212, gathering software 214, analytics software 216, and presentation software 218.

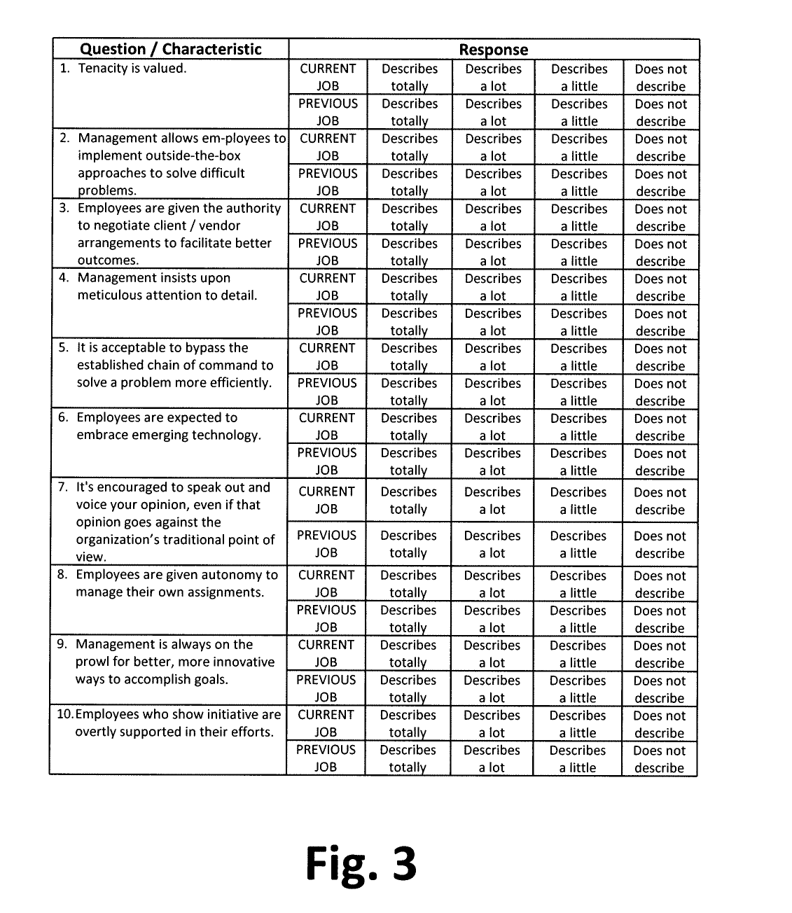

In one aspect of the disclosed invention, the gathering software 214 can present questions to users about an organization's characteristics and receive the users' responses. In one embodiment, the questions and responses can be stored in the information database 212 and can communicated to and from users over the web by using the web hosting software 210. In one embodiment, the questions can be presented in the form of a survey, such as the illustrative survey shown in FIG. 3.

As shown in the exemplary survey of FIG. 3, the questions ask the respondents to provide: (1) their responses how characteristics relate to their current job environment, and (2) their responses regarding how characteristics relate to their previous job environment. This approach of obtaining responses for both the current organization and the previous job environments enables the analytics software 216 to identify characteristics of the current organization that are distinct from those of other organizations. The relative differences in the characteristics of the current job environment versus other competitors' job environments are derived by comparing the answers for the current position with those provided for the previous position(s). In one embodiment, the survey questions can be presented only to respondents who have worked in a similar capacity in a previous organization and/or who have worked in their current job for at least a particular number of months, such as four months. These conditions should allow the responses regarding the current and past job environments to be more accurate. Other conditions can be used to limit distribution of the survey, and they are contemplated to fall within the scope of the disclosed invention.

In one aspect, the survey questions, instructional text, and web interface illustrated in FIG. 3 are customizable based on industry, corporate demographics, individual demographics, office site or location, the structure of a particular organization, and the particular position being analyzed, among other things. For example, certain questions may be common across different industries, such as, without limitation, investment banking, commercial banking, law, medicine, accounting, architecture, airline pilots, law enforcement, construction, entertainment, art, retail sales, or any other industry. In contrast, certain questions may be directed to concerns that are specific to a particular industry or a particular subset of industries. The survey questions can be tailored and customized as desired or required. In one embodiment, the survey responses can also be customized. The illustrative embodiment of FIG. 3 shows four possible responses, but the disclosed invention can encompass another number of responses, such as three or five or another number. Each response can also have a different textual description than those illustrated in FIG. 3.

In one embodiment, the survey respondent can be asked to identify his or her work location if the organization has multiple offices. In one embodiment, the respondent can be asked to identify his or her position title, such as, without limitation, analyst, manager, associate, vice president, executive, member, partner, pilot, sales representative, or any other position title in the organization.

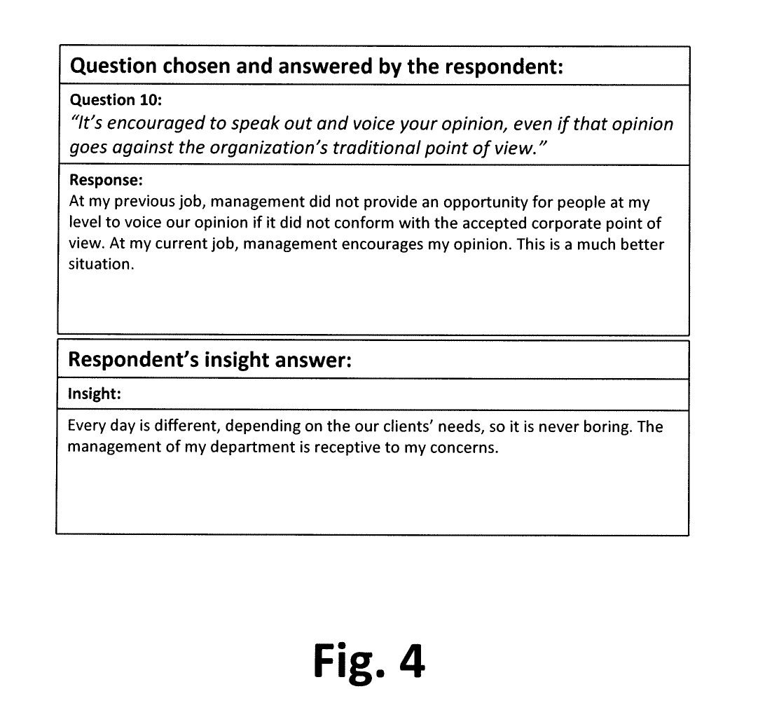

In one embodiment, the disclosed invention can allow respondents to provide written, insightful responses, as shown in FIG. 4. In one embodiment, a respondent can be permitted to provide an insightful response for all questions. In one embodiment, a respondent can be asked to provide insightful responses for only a subset of questions. In one embodiment, the gathering software (214, FIG. 2) can ask a respondent to provide insightful responses only for questions showing a particular difference between the respondent's response for the current job and the respondent's response for the previous job, such as, for example, the difference of “describes a little” for one job and “does not describe” for the other job. This difference threshold is exemplary and another difference threshold can be used to trigger a request for an insightful response. The difference threshold can be customized in the gathering software (214, FIG. 2) and can be applied to all questions, applied to a particular subset of questions, or applied on a question-by-question basis. In one embodiment, a respondent can be asked to provide an overall insightful response about the current organization, with or without any particular difference threshold being triggered. The responses in FIG. 3 and FIG. 4 can be stored in the information database (212, FIG. 2).

Referring now to the analytics software 216 of FIG. 2, the analytics software 216 can access the responses resulting from the gathering software 214 or from some other process, such as a paper survey process or an in-person interview process. In one embodiment, the responses can be stored in the information database 212 and can be accessed by the analytics software 216. As mentioned above, the disclosed invention provides computing systems and methods that statistically characterize an organization. This is in contrast to existing approaches that are based solely on imprecise qualitative perceptions.

In one aspect of the disclosed invention, the analytics software 216 can include an assignment table that associates a predetermined value with each survey response. For example, for the four survey response choices shown in FIG. 3, an exemplary assignment can be as follows:

| | Describes | Describes | Describes | Does Not |
|---|---|---|---|---|
| ANSWER | Totally | A Lot | A Little | Describe |
| VALUE | 12 | 10 | 7 | 1 |

In this exemplary assignment, the values follow what is referred to herein as a “starving man” premise. The “starving man” premise assumes that a starving individual would be much more grateful for a humble meal than a well-fed individual would be for a sumptuous meal at a five-star restaurant. That is, any increment of improvement would mean much more to a starving individual than to a well-fed individual. Using the survey response choices in FIG. 3 as an example, the starving individual can correspond to “does not describe.” The starving man premise dictates that there should be a large jump in the value associated with “describes a little” compared to the value associated with “does not describe.” Accordingly, in the example, “does not describe” is assigned value “1” and “describes a little” is assigned a much larger value “7”, resulting in a jump in value of six. In comparison, the jumps in values associated with the other responses are smaller, to reflect that further incremental gains are not as appreciated compared to the first gain for a starving individual. Accordingly, the jump in value from “describes a little” to “describes a lot” is three, and the jump from “describes a lot” to “describes totally” is two, both of which are smaller than six. The difference of three between the middle answers represents a moderate marginal increase in utility between the two answers “describes a little” and “describes a lot”. The difference of two between “describes a lot” and “describes totally” reflects relatively little emotional distance in utility between the top two answers. (From this point on, in the drawings and the following description, “describes a little” may be used interchangeably with “describes slightly”.)

In various embodiments, the assignment table values need not follow a “starving man” premise and can be modified as desired or as needed. In various embodiments, the assignment table values can include fractional values and/or negative values. In one embodiment, the assignment table can be stored in the information database 212.

In one aspect of the disclosed invention, the analytics software 216 can compare the responses regarding the current job to the responses regarding the previous job for any question/characteristic. The terms “questions” and “characteristic” are used herein interchangeably. In various embodiments, the comparison can use any suitable comparison computation. The following example below describes one particular comparison, but it will be understood that any other comparison computation can be used.

In one embodiment, the analytics software 216 can compare the responses regarding the current job and the responses regarding the previous job for any question across all respondents. For a question “Q.#” and for a respondent “i”, let VALUE_{Current Job, i} denote the value associated with respondent i's response regarding the current job, and let VALUE_{Previous Job,i} denote the value associated with respondent i′s response regarding the previous job. If there are n respondents, then the average value for responses regarding the current job and the average value for responses regarding the previous job from all n respondents are provided by:

$$Q \cdot \# {AvgVALUE}_{CurrentJob} = \frac{1}{n} {\sum }_{i = 1}^{n} {VALUE}_{{CurrentJob}_{i}}$$

$$Q \cdot \# {AvgVALUE}_{PreviousJob} = \frac{1}{n} {\sum }_{i = 1}^{n} {VALUE}_{{PreviousJob}_{i}}$$

A measure of the average response difference for any particular question / characteristic across all respondents can be provided by:

Q.#AvgVALUE_{Current Job}−Q.#AvgVALUE_{Previous Job}=Q.#AvgDIFFERENCE.

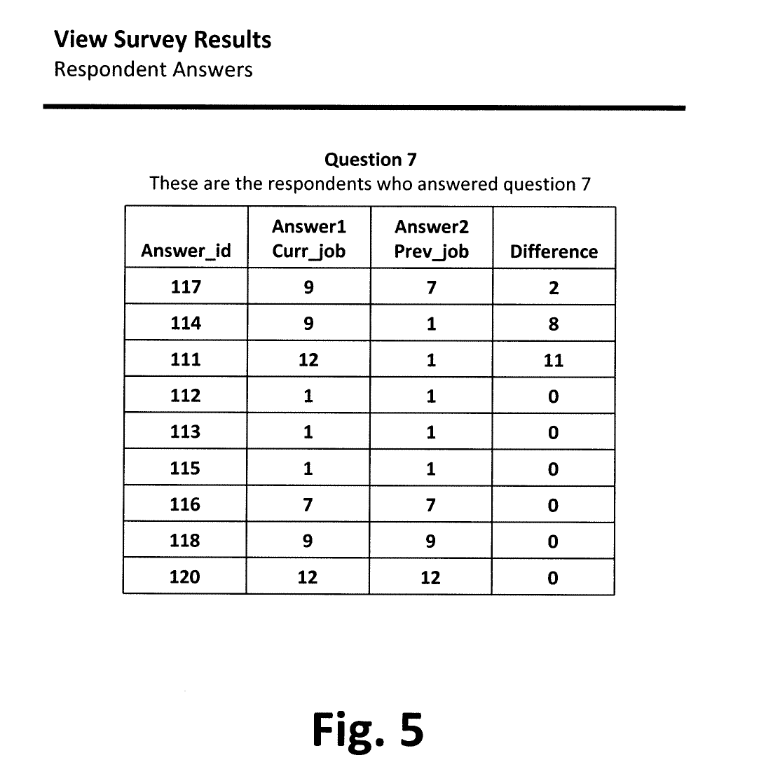

As an example, and with reference to FIG. 5, suppose responses to a particular question seven have the associated values shown in FIG. 5. Based on the nine responses (n=9), the average of the responses regarding the current job would be Q.7AvgVALUE_{Current Job}=6.778, and the average of the responses regarding the previous job would be Q.7AvgVALUE_{Previous Job}=4.444. The difference for question seven would be Q.7AvgDIFFERENCE=2.333:

Q.7AvgVALUE_{Current Job}−Q.7AvgVALUE_{Previous Job}=Q.7AvgDIFFERENCE 6.778−4.444=2.333

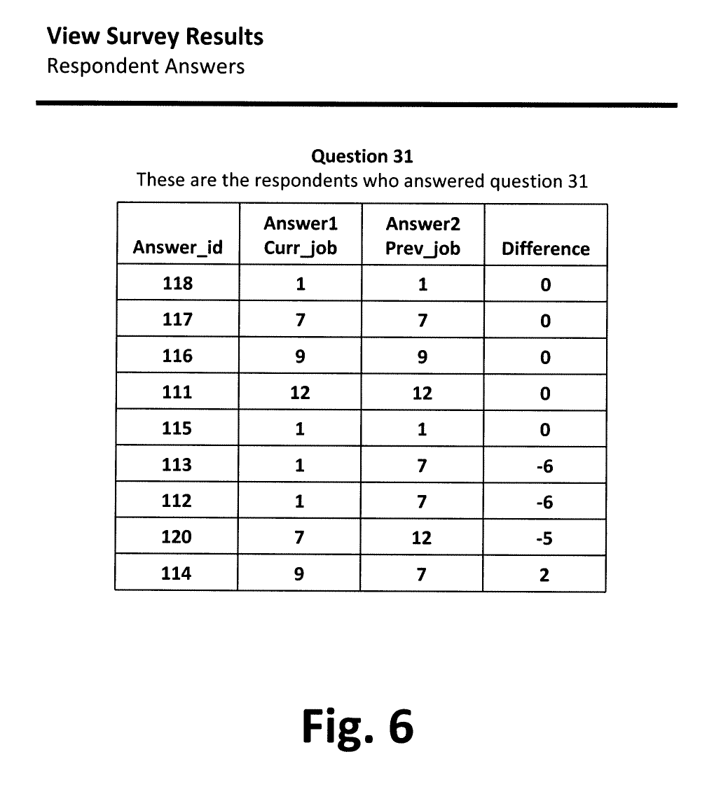

As another example, and with reference to FIG. 6, suppose responses to a particular question thirty-one have the associated values shown in FIG. 6. Based on the nine responses (n=9), the average of the responses regarding the current job would be Q.31AvgVALUE_{Current Job}=5.333, and the average of the responses regarding the previous job would be Q.31AvgVALUE_{Previous Job}=7.000. The difference for question thirty-one would be Q.31AvgDIFFERENCE=−1.667:

Q.31AvgVALUE_{Current Job}−Q.31AvgVALUE_{Previous Job}=Q.31AvgDIFFERENCE 5.333−7.000=−1.667.

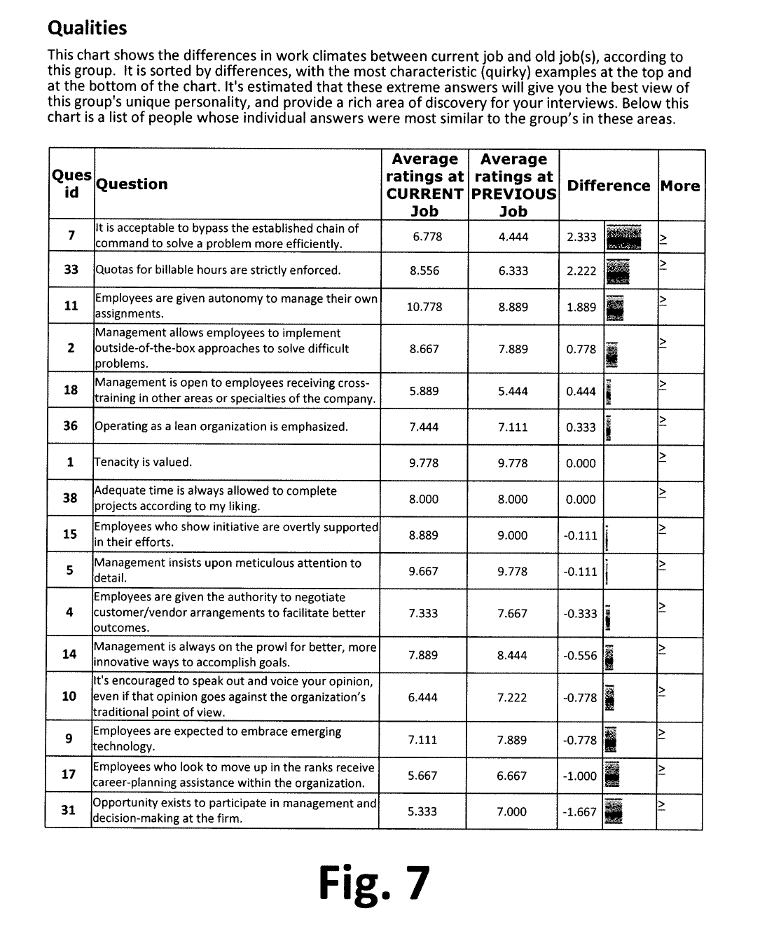

FIG. 7 shows an exemplary display of the above computations Q.#AvgVALUE_{Current Job}, Q.#AvgVALUE_{Previous Job}, and Q.#AvgDIFFERENCE for various organization characteristics. In the illustrated embodiment, the display has sorted the questions/characteristics by the difference Q.#AvgDIFFERENCE, from positive-valued differences to negative-valued differences. The positive-valued differences signify that on average the respondents thought that the characteristic described the current job better than it described the previous job, and the negative-valued differences signify that on average the respondents thought that the characteristic described the previous job better than it described the current job. Because respondents generally come to the current organization from a variety of different organizations, having a sufficiently large sample size of respondents can signify differences in an organization compared to its competitors in general.

In one aspect of the disclosed invention, there need not be inherent judgments accorded to the sign of differences, that is, whether the difference has a positive-value or a negative-value need not be “good” or “bad”. That is, an organization need not shy away from the characteristics reflected by the negative-valued differences, as these characteristics are also distinctive to the organization and are also important to understand.

With continuing reference to FIG. 7, the most positively-valued difference is associated with question/characteristic seven. This may signify that at the subject organization, it is more acceptable to bypass the established chain of command to solve a problem more efficiently, compared to competitors. This characteristic of the subject organization may signify that the organization may be more suitable for “go getters” who have less regard for a chain of command. In FIG. 7, the most negatively-valued difference is associated with question/characteristic thirty-one. This may signify that at the subject organization, fewer opportunities exist to participate in management and decision-making, compared to competitors. This characteristic may signify that the subject organization may be more suitable for employees who are content being workers rather than managers. Putting together characteristics seven and thirty-one suggests that the subject organization may be more suitable for job seekers who are fine with being workers rather than managers, and who are comfortable bypassing the chain of command to finish the work more efficiently. Questions seven and thirty-one are used simply as examples, and other characteristics shown in FIG. 7 may also signify distinctive characteristics of the subject organization. In one embodiment, the average response values and difference values shown in FIG. 7 can be stored in an information database (212, FIG. 2).

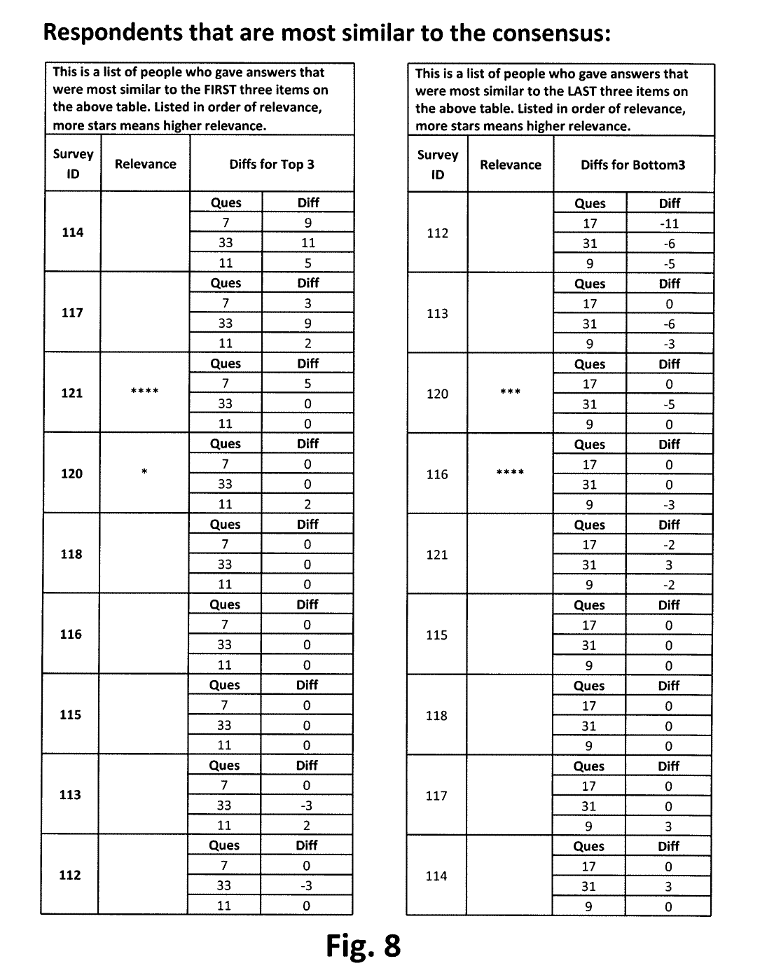

Referring now to FIG. 8 and in accordance with one aspect of the disclosed invention, the analytics software (216, FIG. 2) can determine, for any particular respondent and any particular question/characteristic, the difference between the current job response and the previous job response for that question. In one embodiment, the analytics software can compute the difference between the value associated with the current job response and the value associated with the previous job response. For a particular respondent and for each question number “Q.#”, let Q.#VALUE_{Current Job} denote the value associated with the response to that question regarding the current job, and let Q.#VALUE_{Previous Job} denote the response to that question regarding the previous job. For a respondent, the difference between the value associated with the current job response and the value associated with the previous job is provided by:

Q.#VALUE_{Current Job}−Q.#VALUE_{Previous Job}=Q.#DIFFERENCE.

Using the example assignment table above, this calculation can be summarized by:

| | | | | | Does |
|---|---|---|---|---|---|
| DIFFER- | PREVIOUS | Describes | Describes | Describes | not de- |
| ENCE | POSITION | totally | a lot | a little | scribe |
| CURRENT | VALUE | 12 | 10 | 7 | 1 |
| POSITION | | | | | |
| Describes | 12 | 0 | 2 | 5 | 11 |
| totally | | | | | |
| Describes | 10 | −2 | 0 | 3 | 9 |
| a lot | | | | | |
| Describes | 7 | −5 | −3 | 0 | 6 |
| a little | | | | | |
| Does not | 1 | −11 | −9 | −6 | 0 |
| describe | | | | | |

In FIG. 8, response differences from several respondents are shown for questions seven, thirty three, and eleven, which are the three questions/characteristics from FIG. 7 having the highest positive-value differences between average current job responses and average previous job responses; specifically, 2.333, 2.222, and 1.889. The respondents' response differences are also shown for questions thirty-one, seventeen, and nine, which are the three questions/characteristics from FIG. 7 having the lowest negative-value differences; specifically −1.667, −1.000, and −0.778. These six characteristics may reflect the most distinctive characteristics of the subject organization.

In one embodiment, the analytics software (216, FIG. 2) can determine how similar each respondent's responses are to these distinctive characteristics. This similarity is shown in FIG. 8 as “relevance”, where a four-star relevance indicates very high similarity and one star indicates moderate similarity, and so on for two and three stars. Relevance/similarity can be computed in many different ways that will be known to those skilled in the art. One way to compute relevance is using t-test statistics, as described below.

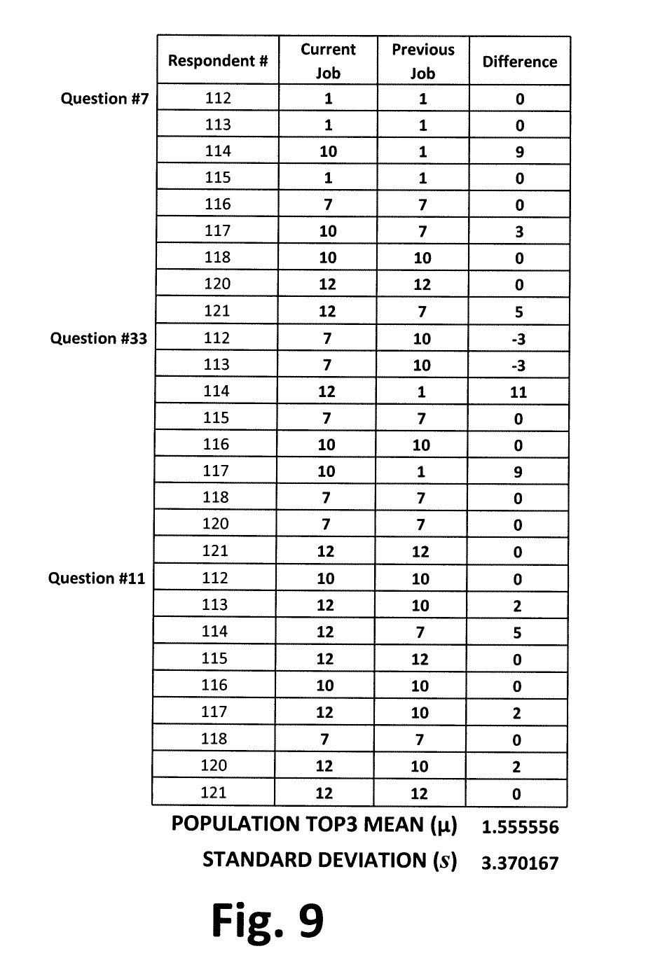

Referring to FIG. 9, there is shown a table of responses to the three questions having the highest positive-value differences between average current job responses and average previous job responses, that is, questions seven, thirty-three, and eleven. Based on these responses, the mean and standard deviation of all of the differences can be computed. Those skilled in the art will recognize how to compute mean and standard deviation. As shown in FIG. 9, the mean can be referred to as “population top three mean” and can be denoted as μ, and the standard deviation can be denoted as S. Using the responses in FIG. 9, the population top three mean is approximately μ=1.555556, and the standard deviation is about S=3.370167.

Using the standard deviation and the number of questions (denoted as n), a standard error of respondent sample mean s _{x̅} can be computed as:

$${s}_{\overline{x}} = \frac{s}{\sqrt{n}} .$$

In the table of FIG. 9, the number of questions n=3. Thus, s _{x̅}=3.370167/sqrt(3), which is about s _{x̅}=1.945767.

The t-test statistic for a particular respondent is computed by:

$$t = \frac{\overline{X} - μ}{{S}_{\overline{x}}} .$$

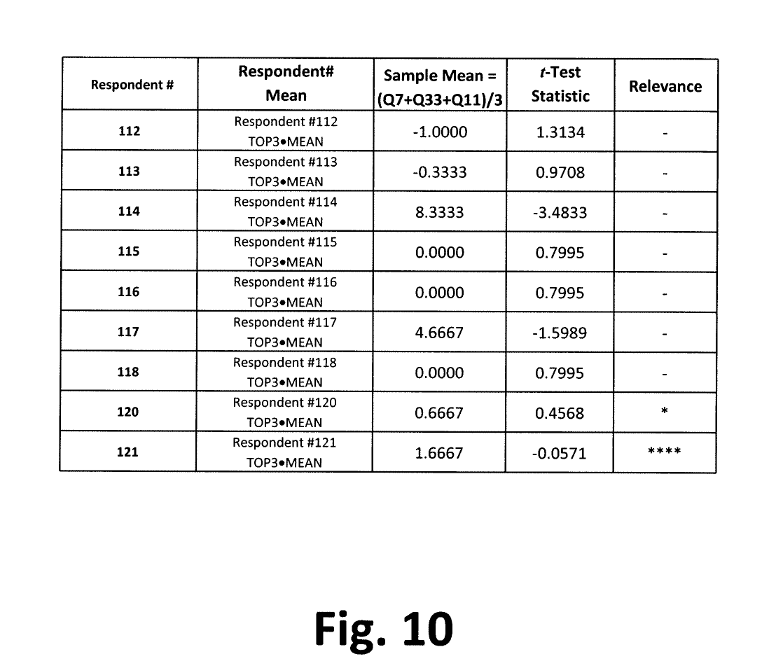

x̅ denotes the mean of the particular respondent's responses to the three questions. Using the above example, x̅=(Q7+Q33+Q11)/3, which is shown in FIG. 10 for each respondent.

In one aspect of the disclosed invention, a particular respondent's similarity/relevance is determined based on the value of the t-test statistic. In one embodiment, the relevance star rating can be determined based on the absolute value of the t-test statistic as follows:

| | \|t-test statistic\| Within Range | | | | |
|---|---|---|---|---|---|
| | ≧0.0, ≦0.2 | >0.2, ≦0.3 | >0.3, ≦0.4 | >0.4, ≦0.5 | >0.5 |
| Rele- | **** | *** | ** | * | — |
| vance | | | | | |

Shown in FIG. 10 are the similarity / relevance computation results for each respondent in FIG. 9.

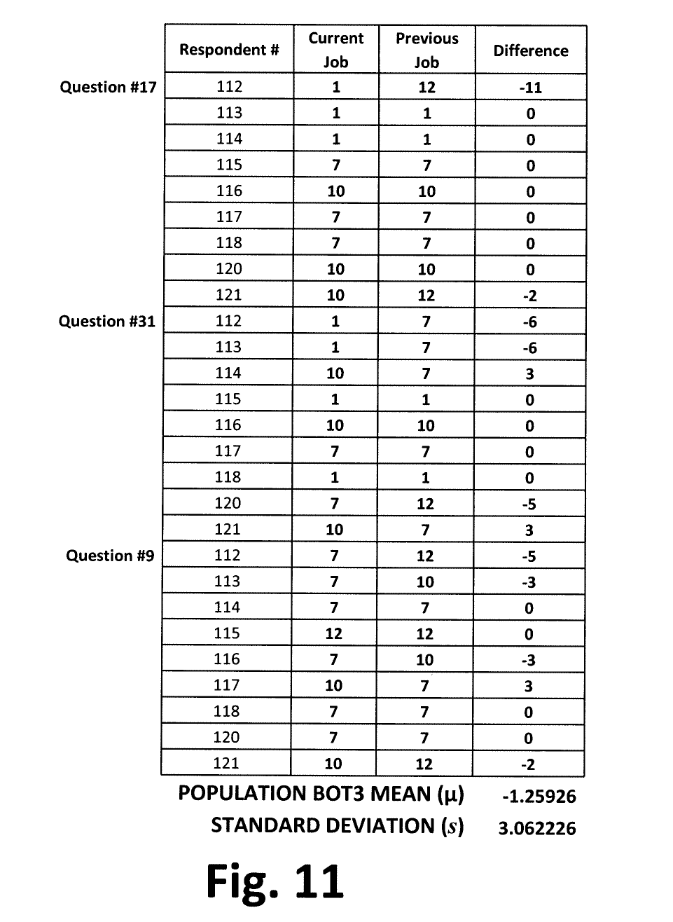

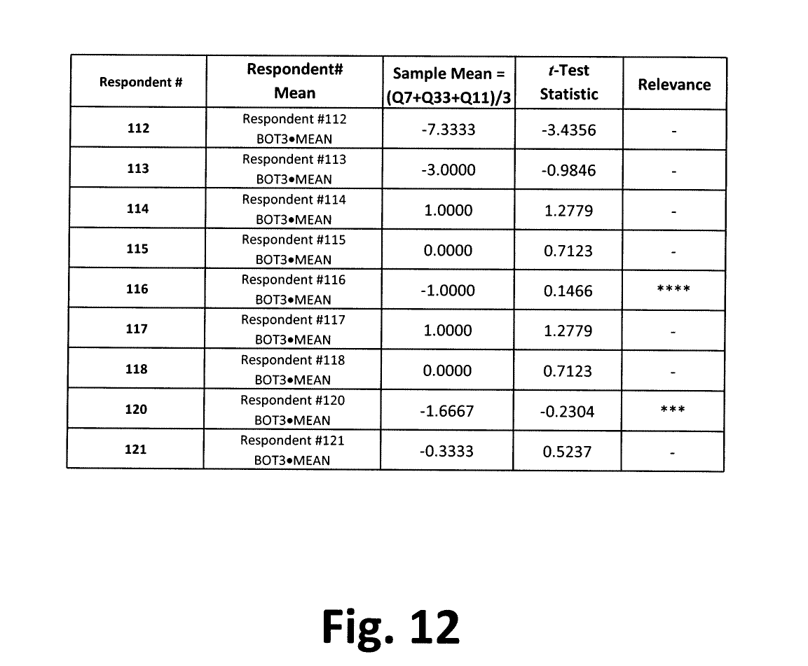

FIG. 11 and FIG. 12 show the respondent data and similarity computations for the three questions having the most negative-valued differences, that is, questions seventeen, thirty-one, and nine. As shown in FIG. 11, the population bottom three mean is approximately μ=−1.25926 and the standard deviation is about S=3.062226. The t-test statistics and star-ratings are shown in FIG. 12.

In various embodiments, the analysis and computations in FIGS. 8-12 need not be limited to three highest positive-value differences and three lowest negative-value differences, and another number of questions can be used. For example, in other embodiments, the top three (or another number of) absolute-value differences can be selected. Additionally, the similarity computations above are exemplary and do not limit the scope of the disclosed invention. Other similarity computations and statistical metrics are contemplated to fall within the scope of the disclosed invention.

The above description has described the gathering software 214 and the analytics software 214 of FIG. 2. The following paragraphs will now describe the presentation software 218, which can access information in the information database 212 and format it for presentation to users who wish to view the survey and analysis results.

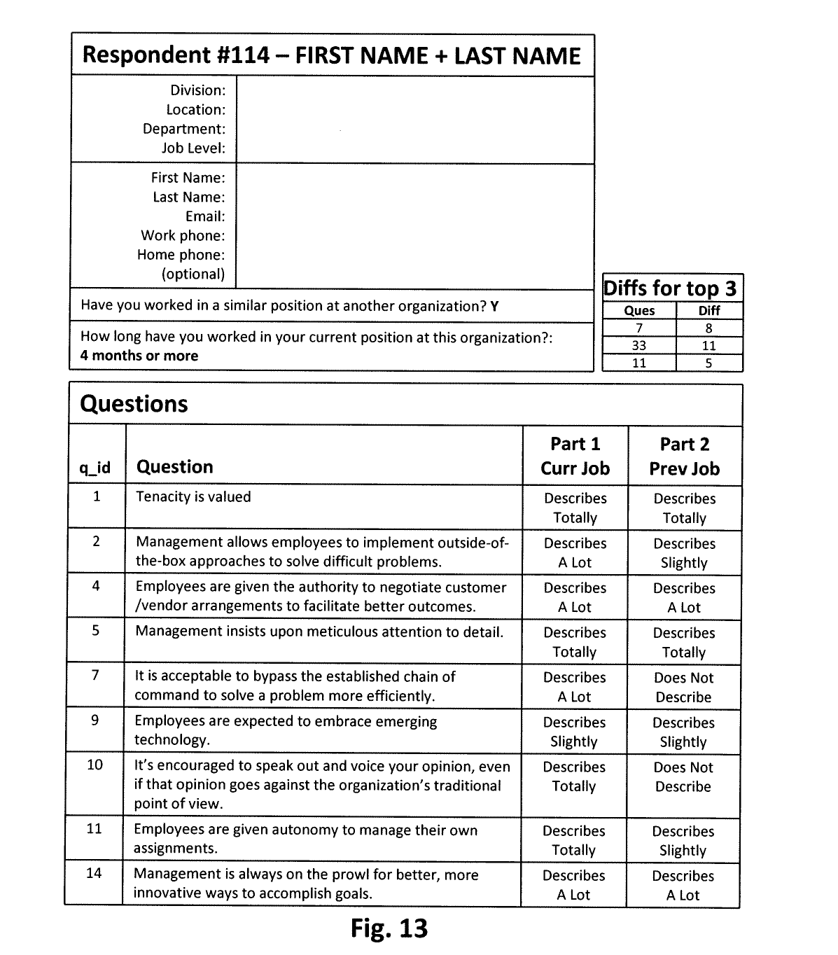

In one embodiment, and with reference to FIG. 13, the presentation software 218 can access and display information regarding a respondent, including respondent number, job division, job location, job level, and job department, among other things. The presentation software 218 can also access and display personal information such as first name, last name, e-mail address, work phone, and home phone, among other things. Other information about a respondent can also be accessed and displayed. The presentation software 218 can access and display the survey questions and the respondent's responses for each survey question. In the illustrated embodiment, the presentation software 218 can access and display the respondent's response differences for particular questions, such as the questions having the greatest positive-value differences from FIG. 7.

Referring to FIGS. 5 and 6, the presentation software 218 can access and display response from all respondents for a particular question, and can display each respondent's response difference for the current job and the previous job for the particular question/characteristic. Referring to FIG. 7, the presentation software 218 can access and display the computed average response values for each question/characteristic, and the computed difference for each question/characteristic. In the illustrated embodiment, questions/characteristics can be sorted by the value of the difference. As shown in FIG. 7, the sorting can be arranged from the most positive difference to the most negative difference, but another sort or no sorting can be used. A particular number of highest positive-value differences and a particular number of lowest negative-value differences, that is, the most distinctive characteristics, can be presented in one or more different row colors compared to other questions/characteristics. Referring to FIG. 8, the presentation software 218 can access and display a particular number of distinctive characteristics and show how similar each respondent's responses are to those characteristics.

Other displays of the information described herein are also within the spirit and scope of the invention. The disclosed aspects and embodiments are exemplary, and do not limit the scope of the invention. For example, in one embodiment, the presentation software 218 can present respondent responses by corporate division, location, department and job level, among other selection criteria. Variances in responses among sub-groups may be of interest to management and can assist in better defining an organization's distinctions. In one embodiment, the presentation software 218 can present response information based on certain selection criteria, such as gender, age, race, ethnicity, disability and zip code, among others. Such presentations allow comparing and contrasting average response difference among particular sub-groups and may lead to better targeted “job branding,” as well as help an organization with their EOE initiatives

Although various embodiments have been described herein for computing response differences, other statistical computations may be used. For larger numbers of respondents, standard deviations can be employed to support clarity in measuring differences. In one embodiment, instead of comparing the mean value of current job responses and the mean value of previous job responses to calculate a difference, skewness may be calculated and analyzed, providing greater granularity in the analyses. In situations where a corporation has disparate locations, t-tests could be employed to compare the difference between two means (populations). In one aspect, the disclosed invention may aggregate several survey results to prepare industry norms that may be useful for benchmarking purposes.

In one aspect, the result of the analyses disclosed herein can be used with best practices or novel thinking associated with tools used by human resources departments to develop insights about employees. The embodiment and aspects disclosed herein are directed to uncover “hidden motivators” and to address a candidate's unarticulated side, but other tools may be employed to achieve deep psychological dialog between employer and candidates.

What have been described above herein are computing systems and methods for gathering, analyzing, and presenting information to statistically characterize an organization. It will be understood that these examples do not limit the spirit and scope of the disclosed invention. It is contemplated that the various embodiments disclosed herein are not exclusive and can be combined in different ways to provide the technology disclosed herein.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

Although the present invention has been described in relation to particular embodiments thereof, these embodiments and examples are merely exemplary and not intended to be limiting. Many other variations and modifications and other uses will become apparent to those skilled in the art. The present invention should, therefore, not be limited by the specific disclosure herein, and may be embodied in other forms not explicitly described here, without departing from the spirit thereof.

1. A computing system for statistically characterizing an organization, the computing system comprising:
at least one computer readable medium comprising:
a plurality of characteristics regarding organizations,
a plurality of data regarding the characteristics in relation to a first organization and regarding the characteristics in relation to other organizations, and
software for analyzing the plurality of data to determine distinctive characteristics of the first organization; and
at least one processor executing the software, wherein the software when executed causes the computing system to perform steps comprising identifying, based on the plurality of data, a first characteristic among the characteristics that, statistically more than any of the other characteristics, relates to the first organization more than it relates to other organizations.

2. A computing system as in claim 1, wherein the software when executed causes the computer system to perform further steps comprising identifying, based on the plurality of data, a second characteristic among the characteristics that, statistically more than any of the other characteristics, relates to other organizations more than it relates to the first organization.

3. A computing system as in claim 2, wherein the plurality of data comprises survey responses indicating how the characteristics relate to the first organization and how the characteristics relate to the other organizations.

4. A computing system as in claim 3, wherein the at least one computer readable medium further comprises software for gathering the survey responses.

5. A computing system as in claim 3, wherein the survey response includes at least four levels indicating how the characteristics relate to the first organization and how the characteristics relate to the other organizations.

6. A computing system as in claim 3, wherein the software when executed causes the computing system to perform further steps comprising:
for each characteristic:
computing a first average value indicating the average of the survey responses indicating how the characteristic relates to the first organization,
computing a second average value indicating the average of the survey responses indicating how the characteristic relates to the other organizations, and
computing a difference between the first average value and the second average value.

7. A computing system as in claim 6, wherein identifying the first characteristic comprises identifying the one characteristic having the most positive-valued difference among the characteristics.

8. A computing system as in claim 6, wherein identifying the second characteristic comprises identifying the one characteristic having the most negative-valued difference among the characteristics.

9. A computing system as in claim 6, wherein computing the first average value and computing the second average value are based on an assignment table that associates values with survey responses.

10. A computing system as in claim 9, wherein the assignment table associates values with survey response based on a starving man premise.

11. A computing system as in claim 3, wherein the software when executed causes the computing system to perform further steps comprising computing similarity between at least one of the survey responses and the first characteristic.

12. A computing system as in claim 3, wherein the software when executed causes the computing system to perform further steps comprising computing similarity between at least one of the survey responses and the second characteristic.
